(19) United States
(12) Patent Application Publication
(10) Pub. No.: US 2025/0289381 A1
(43) Pub. Date: Sep. 18, 2025

(54) ELECTRONIC SYSTEM MOUNTED ON VEHICLE INCLUDING EXTERNAL STORAGE DEVICE AND METHOD OF OPERATING SAME

(71) Applicant: SAMSUNG ELECTRONICS CO., LTD., Suwon-si (KR)

(72) Inventors: Seongchan JO, Suwon-si (KR); Myeongjong LEE, Suwon-si (KR); Hyungsup KIM, Suwon-si (KR); Younsung CHU, Suwon-si (KR)

(73) Assignee: SAMSUNG ELECTRONICS CO., LTD., Suwon-si (KR)

(21) Appl. No.: 18/968,663

(22) Filed: Dec. 4, 2024

(30) Foreign Application Priority Data
Mar. 12, 2024 (KR) 10-2024-0034610

(51) Int. Cl. B60R 16/023; G06F 3/06; G06F 21/62

(52) U.S. Cl. CPC B60R 16/023; G06F 3/0604; G06F 3/0634; G06F 3/0653; G06F 21/6218

(57) ABSTRACT

An electronic system mounted on a vehicle is provided and includes: a first user device including a first electronic control unit (ECU) and a first internal storage device; an external storage device including a first device function, exclusively allocated to the first ECU, and a non-volatile memory device; and an integrated controller configured to: select a hybrid mode among an internal mode and the hybrid mode as a storage mode of the first ECU; activate the first device function based on selecting the hybrid mode; and provide a first control signal indicating the hybrid mode to the first ECU, wherein the first ECU is configured to, based on the first ECU receiving the first control signal, store a first piece of first data in the first internal storage device and store, through the first device function, a second piece of the first data in the non-volatile memory device.

### CROSS-REFERENCE TO RELATED APPLICATIONS

This application claims priority under 35 U.S.C. § 119 to Korean Patent Application No. 10-2024-0034610, filed on Mar. 12, 2024, in the Korean Intellectual Property Office, the disclosure of which is incorporated by reference herein in its entirety.

### BACKGROUND

### 1. Field

Embodiments of the present disclosure described herein relate to an electronic system mounted on a vehicle, and more particularly, relate to an electronic system mounted on a vehicle including an external storage device and an operating method thereof.

### 2. Brief Description of Related Art

A semiconductor memory is classified as a volatile memory (e.g., static random access memory (SRAM) or a dynamic random access memory (DRAM)), which loses data stored therein when a power is turned off, or a non-volatile memory device (e.g., a flash memory, a phase-change RAM (PRAM), a magnetic RAM (MRAM), a resistive RAM (RRAM), or a ferroelectric RAM (FRAM)), which retains data stored therein even when a power is turned off.

A flash memory device may be a representative example of the non-volatile memory device. The flash memory device is widely used as a medium for storing audio and image data of information devices such as a computer, a mobile phone, a smartphone, a personal digital assistant (PDA), a digital camera, a camcorder, a voice recorder, an MP3 player, a personal portable terminal, a handheld PC, a game console, a facsimile, a scanner, and a printer. Nowadays, high-capacity, high-speed input/output, and low-power technologies for the non-volatile memory device are actively studied to mount the flash memory device on a mobile device such as a smartphone.

As the demand for a high-capacity non-volatile memory device increases, in general, a multi-level cell (MLC) or multi-bit memory device which stores multiple bits per memory cell is used. In particular, in the case of a vehicle where various electronic devices are mounted, it is difficult to store a large amount of data generated for a long time only by using internal memory devices included in the electronic devices.

Accordingly, there is being discussed various methods for storing data of electronic devices mounted on the vehicle.

### SUMMARY

Embodiments of the present disclosure provide an electronic system mounted on a vehicle including an external storage device and an operating method thereof.

According to embodiments of the present disclosure, an electronic system mounted on a vehicle is provided and includes: a first user device including a first electronic control unit (ECU) and a first internal storage device; an external storage device including a first device function, exclusively allocated to the first ECU, and a non-volatile memory device; and an integrated controller configured to: select a hybrid mode among an internal mode and the hybrid mode as a storage mode of the first ECU; activate the first device function based on selecting the hybrid mode; and provide a first control signal indicating the hybrid mode to the first ECU, wherein the first ECU is configured to, based on the first ECU receiving the first control signal, store a first piece of first data in the first internal storage device and store, through the first device function, a second piece of the first data in the non-volatile memory device.

According to embodiments of the present disclosure, a method of operating an electronic system that is mounted on a vehicle and includes an integrated controller, a first user device, and an external storage device, is provided. The method includes: selecting, by the integrated controller, a hybrid mode among an internal mode and the hybrid mode as a storage mode of a first electronic control unit (ECU) of the first user device; activating, by the integrated controller, a first device function of the external storage device based on the integrated controller selecting the hybrid mode; activating, by the first device function that is activated, a data path between the first ECU and a non-volatile memory device of the external storage device; providing a first control signal indicating the hybrid mode to the first ECU based on the integrated controller selecting the hybrid mode; storing, by the first ECU and based on the first ECU receiving the first control signal, a first piece of first data in a first internal storage device of the first user device; and storing, by the first ECU and based on the first ECU receiving the first control signal, a second piece of the first data in the non-volatile memory device through the first device function.

According to embodiments of the present disclosure, an electronic system is provided and includes: a first user device; an external storage device including a first device function configured to be exclusively allocated to the first user device; and an controller configured to: select a hybrid mode among an internal mode and the hybrid mode as a storage mode of the first user device; activate the first device function based on selecting the hybrid mode; and provide a first control signal indicating the hybrid mode to the first user device, wherein the first user device is configured to, based on the first user device receiving the first control signal, store a first piece of first data in the first user device and store, through the first device function, a second piece of the first data in the external storage device.

### BRIEF DESCRIPTION OF DRAWINGS

The above and other aspects and features of embodiments of the present disclosure will become apparent by describing in detail non-limiting example embodiments thereof with reference to the accompanying drawings.

FIG. 1 is a block diagram of an electronic system according to an embodiment of the present disclosure.

FIG. 2 is a block diagram of an electronic system according to some embodiments of the present disclosure.

FIG. 3 is a flowchart describing an operating method of an electronic system of FIG. 1, according to some embodiments of the present disclosure.

FIG. 4 is a flowchart describing an operating method of an electronic system according to some embodiments of the present disclosure.

FIG. 5 is a diagram describing an event table according to some embodiments of the present disclosure.

FIG. 6 is a flowchart describing an operating method of an electronic system according to some embodiments of the present disclosure.

FIG. 7A is a diagram describing a change of a storage device according to some embodiments of the present disclosure.

FIG. 7B is a diagram describing a change of a storage device according to some embodiments of the present disclosure.

FIG. 8 is a diagram describing how data is transmitted between a plurality of user devices and an external storage device, according to some embodiments of the present disclosure.

FIG. 9 is a diagram describing a controller area network (CAN) frame according to some embodiments of the present disclosure.

### DETAILED DESCRIPTION

Non-limiting example embodiments of the present disclosure will be described below in detail and clearly to such an extent that one skilled in the art carries out embodiments of the present disclosure easily.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

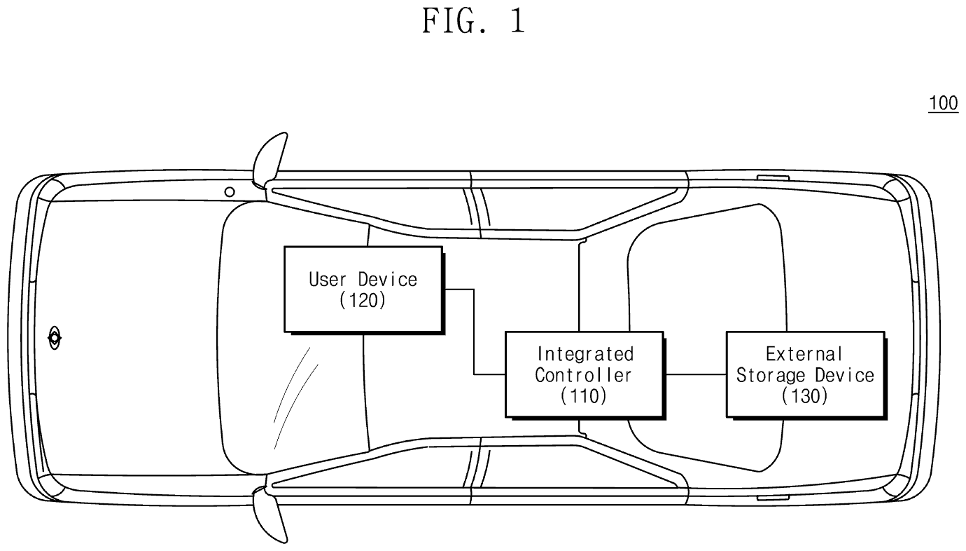

FIG. 1 is a block diagram of an electronic system according to an embodiment of the present disclosure. Referring to FIG. 1, an electronic system 100 may be mounted on a vehicle or other various means of transportation (e.g., a train, an airplane, and a robot). For example, the electronic system 100 may include various electronic devices mounted on a vehicle or other various means of transportation. However, a vehicle or other various means of transportation are provided as an example for better understanding example embodiments of the present disclosure, and the vehicle and the various transport means are not intended to limit the scope and spirit of the present disclosure. The electronic system 100 may include an integrated controller 110, a user device 120, and an external storage device 130.

The electronic system 100 may process various information and/or may store the processed information as data. For example, the electronic system 100 may process various information for operations or management of the vehicle or other various means of transportation or may store the processed information as data. The electronic system 100 may require high-capacity storage to store the processed information as data.

In some embodiments, the electronic system 100 may be implemented with a computing system such as a personal computer (PC), a notebook, a laptop, a server, a workstation, a tablet PC, a smartphone, a digital camera, or a black box.

The integrated controller 110 may control all the operations of the electronic system 100. For example, the integrated controller 110 may control the user device 120 and the external storage device 130 of the electronic system 100. In some embodiments, the integrated controller 110 may determine a storage mode of the user device 120. For example, the integrated controller 110 may select one from among an internal mode, an external mode, and a hybrid mode as the storage mode of the user device 120. The storage mode may indicate an operation state of the user device 120, which indicates whether the user device 120 stores data in any storage among an internal storage device of the user device 120 and the external storage device 130.

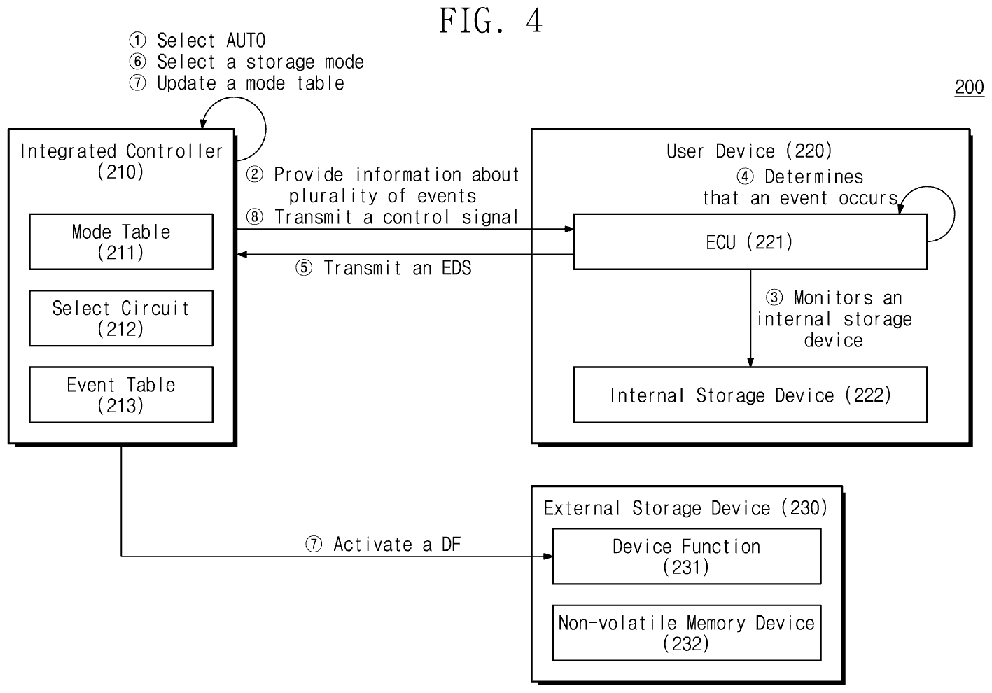

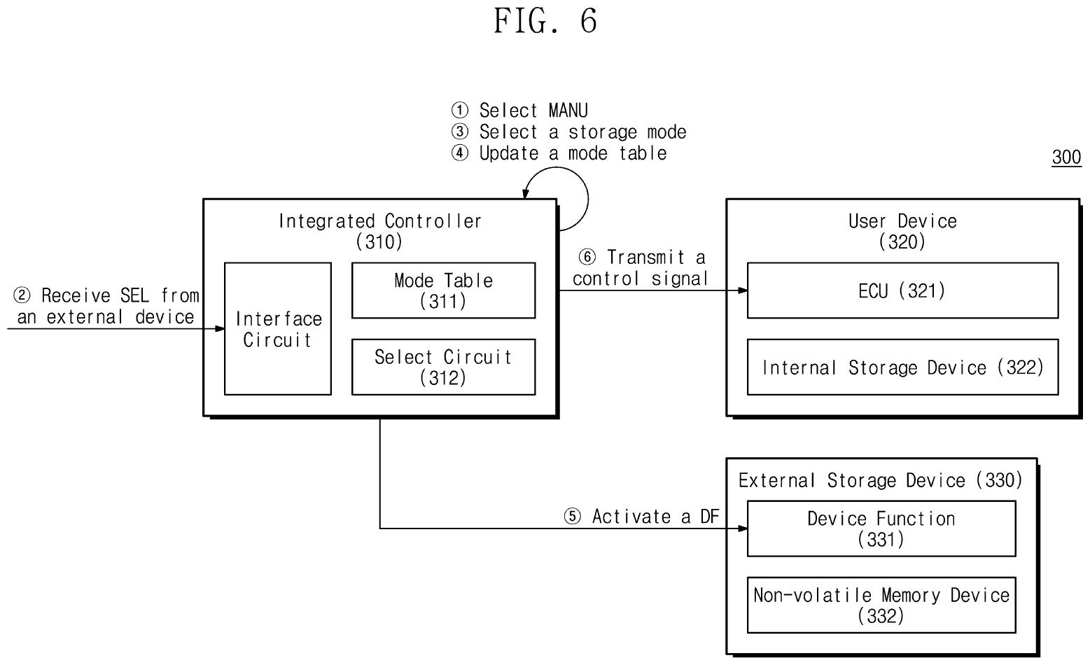

That is, the integrated controller 110 may control the user device 120 by determining the storage mode indicating whether the user device 120 stores data in any storage among the internal storage device of the user device 120 and the external storage device 130. The storage mode will be described in detail with reference to FIGS. 4 and 6.

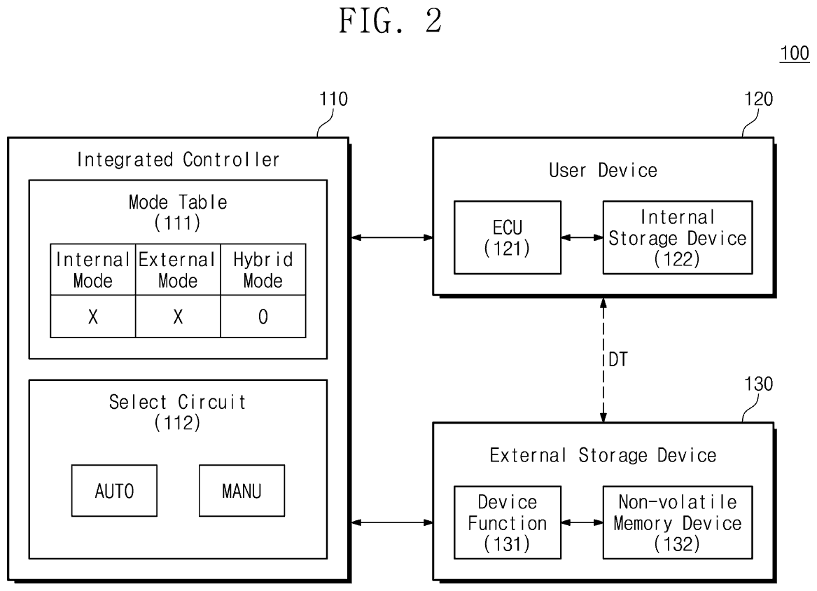

In some embodiments, the integrated controller 110 may control the external storage device 130. For example, the integrated controller 110 may control the external storage device 130 for data transmission between the user device 120 and the external storage device 130. The data transmission between the user device 120 and the external storage device 130 will be described in detail with reference to FIG. 2.

The user device 120 may generate data and may store generated information in storage. For example, the user device 120 may process information and may generate data; the user device 120 may store the generated information in the user device 120 or may store the generated information in the external storage device 130.

In some embodiments, the user device 120 may be an electronic device mounted as a component of a vehicle or other various means of transportation (e.g., a train, an airplane, and a robot). For example, the user device 120 may be a black box, an advanced driver assistance system (ADAS), an in-vehicle infotainment (IVI), an air conditioner, a smart room mirror, or the like. The user device 120 may process various information for management or operations of a vehicle or other various means of transportation and may generate data. The data may be various kinds of data such as a voice, a video, and control data.

In some embodiments, the user device 120 may store data in the user device 120 and/or the external storage device 130 based on the storage mode. For example, when the storage mode is the internal mode, the user device 120 may store data in the user device 120. When the storage mode is the external mode, the user device 120 may store data in the external storage device 130. When the storage mode is the hybrid mode, the user device 120 may store data in the user device 120 and the external storage device 130 together.

The external storage device 130 may store data. For example, the external storage device 130 may receive data from the user device 120 and may store the received data. The external storage device 130 may store all or part of the data which the user device 120 generates. Also, under control of the user device 120, the external storage device 130 may provide the stored data to the user device 120.

In some embodiments, the external storage device 130 may support data communication. For example, under control of the integrated controller 110, the external storage device 130 may support the data communication between the user device 120 and the external storage device 130.

In some embodiments, the external storage device 130 may support “crypto erase.” For example, the external storage device 130 may encrypt data by using an encryption key according to a crypto erase function and may store the encrypted data. The external storage device 130 may delete the encryption key, and thus, it may be impossible to read the encrypted data. The external storage device 130 may delete all or part of data stored in the external storage device 130 or may make the readout of all or part of the data impossible. That is, as the external storage device 130 supports the crypto erase, the security of data stored therein may be reinforced.

In some embodiments, the external storage device 130 may be removable from the electronic system 100. For example, the electronic system 100 may further include an interface circuit which is electrically connected to the integrated controller 110 and is detachably connected to the external storage device 130. The external storage device 130 may be connected to the integrated controller 110 through the interface circuit and may be removable from the interface circuit. Also, some components (e.g., a non-volatile memory device in the external storage device 130) of the external storage device 130 may be removable from the external storage device 130 or the interface circuit.

In some embodiments, the external storage device 130 may be embedded in a vehicle or other various means of transportation (e.g., a train, an airplane, and a robot) and may be fixedly connected to the integrated controller 110. For example, the external storage device 130 may be fixed so as not to be separated in a daily operating environment of a vehicle or other various means of transportation. That is, the external storage device 130 may be fixedly connected to a vehicle or other various means of transportation, and thus, leakage of data due to the loss or theft of the external storage device 130 may be prevented.

FIG. 2 is a block diagram of an electronic system according to some embodiments of the present disclosure. Referring to FIG. 2, the electronic system 100 may include the integrated controller 110, the user device 120, and the external storage device 130.

The integrated controller 110 may include a mode table 111 and a select circuit 112. The mode table 111 may include information about the storage mode of the user device 120 (e.g., an electronic control unit (ECU) 121). For example, the mode table 111 may include information about whether the storage mode is the internal mode, the external mode, or the hybrid mode. The mode table 111 may indicate one from among the internal mode, the external mode, and the hybrid mode as the storage mode.

In some embodiments, the integrated controller 110 may update the mode table 111 in the integrated controller 110 in response to changing the storage mode of the user device 120. For example, when the storage mode of the user device 120 was the internal mode, afterwards, the integrated controller 110 may select the hybrid mode as the storage mode of the user device 120 (i.e., may change the storage mode from the internal mode to the hybrid mode) and may update the mode table 111, with mode information corresponding to the user device 120 in response to selecting the hybrid mode. That is, the mode table 111 may be updated to include information about the selected storage mode of the user device 120.

The select circuit 112 may determine an operation mode of the integrated controller 110. For example, the select circuit 112 may select one from among an auto-mode AUTO and a manual mode MANU as the operation mode of the integrated controller 110. The operation mode may indicate a state where the integrated controller 110 controls the user device 120. In some embodiments, after the select circuit 112 selects the auto-mode AUTO as the operation mode, the select circuit 112 may select the manual mode MANU (i.e., may change the operation mode from the auto-mode AUTO to the manual mode MANU);

alternatively, after the select circuit 112 selects the manual mode MANU as the operation mode, the select circuit 112 may select the auto-mode AUTO (i.e., may change the operation mode from the manual mode MANU to the auto-mode AUTO).

In some embodiments, based on the operation mode, the integrated controller 110 may determine the storage mode of the user device 120 (i.e., may select one from among the internal mode, the external mode, and the hybrid mode as the storage mode). For example, when the operation mode is the auto-mode AUTO, the integrated controller 110 may determine the storage mode of the user device 120 based on a result of monitoring, at the ECU 121 of the user device 120, an internal storage device 122 of the user device 120. Also, when the operation mode is the manual mode MANU, the integrated controller 110 may determine the storage mode of the user device 120 based on a signal received from an external device. The operation mode of the integrated controller 110 will be described in detail with reference to FIGS. 4 and 6.

The integrated controller 110 may communicate with the user device 120. For example, the integrated controller 110 may provide the user device 120 with a control signal indicating the storage mode (e.g., one from among the internal mode, the external mode, and the hybrid mode) of the user device 120. In some embodiments, in response to determining the storage mode of the user device 120, the integrated controller 110 may update mode information corresponding to the user device 120 in the mode table 111 and may provide the control signal indicating the storage mode to the user device 120. The integrated controller 110 may communicate with the user device 120 by using a communication standard such as a controller area network (CAN), a local interconnect network (LIN), or a FlexRay.

The integrated controller 110 may control the external storage device 130. For example, the integrated controller 110 may activate or deactivate a device function 131 of the external storage device 130. The device function 131 may be a physical function (PF) or a virtual function (VF) which manages an input/output (I/O) to support the data transmission between the user device 120 and the external storage device 130. The device function 131 will be described in detail later based on the external storage device 130 of FIG. 2. According to embodiments of the present disclosure, a “device function” may be, for example, a hardware device and/or software stored in a memory and/or a process performed by the hardware device and/or the software.

The user device 120 may include the ECU 121 and the internal storage device 122. The ECU 121 may generate data DT of the user device 120. For example, while the user device 120 operates, the ECU 121 may process information and may generate the data DT.

The ECU 121 may provide the generated data to the internal storage device 122 or the external storage device 130. For example, the ECU 121 may provide the data to the internal storage device 122 and/or the external storage device 130 depending on the storage mode of the user device 120. In some embodiments, when the storage mode is the internal mode, the ECU 121 may provide the entire generated data to the internal storage device 122. When the storage mode is the external mode, the ECU 121 may provide the entire generated data to the external storage device 130. When the storage mode is the hybrid mode, the ECU 121 may provide a first piece of the generated data to the internal storage device 122 and may provide a second piece of the generated data to the external storage device 130.

The ECU 121 may monitor the internal storage device 122. For example, the ECU 121 may monitor a used space or a used age of the internal storage device 122. For example, the ECU 121 may monitor whether the used space of the internal storage device 122 exceeds a first threshold value (e.g., a specific ratio of the entire space) or may monitor whether the used age of the internal storage device 122 exceeds a second threshold value (e.g., a specific endurance period).

In some embodiments, when the integrated controller 110 operates in the auto-mode AUTO, the ECU 121 may provide a signal to the integrated controller 110 based on a result of monitoring the internal storage device 122 and may receive the control signal indicating the storage mode of the user device 120 from the integrated controller 110. For example, when the integrated controller 110 operates in the auto-mode AUTO, the ECU 121 may determine that the used age of the internal storage device 122 exceeds the specific endurance period and may provide the signal to the integrated controller 110. How the ECU 121 monitors the internal storage device 122 will be described in detail with reference to FIG. 4.

The internal storage device 122 may store data. For example, the internal storage device 122 may store all or part of the data which the ECU 121 generates. The internal storage device 122 may store data or may provide the stored data to the ECU 121 under control of the ECU 121. The internal storage device 122 may include a plurality of memory chips. The memory chips of the internal storage device 122 may retain data stored therein even though a power supply is interrupted. For example, the memory chips of the internal storage device 122 may be implemented with a NAND (Not AND) flash memory device, a NOR (Not OR) flash memory device, a phase-change RAM (PRAM), a magnetic RAM (MRAM), a resistive RAM (RRAM), etc.

The external storage device 130 may communicate with the user device 120. For example, the external storage device 130 may be connected to the integrated controller 110, and the integrated controller 110 may be connected to the user device 120. That is, the external storage device 130 may be connected to the user device 120 through the integrated controller 110 and may communicate with the user device 120. In some embodiments, the external storage device 130 may receive the data DT from the user device 120 through the integrated controller 110 and may store the received data DT.

The external storage device 130 may include the device function 131 and a non-volatile memory device 132. In some embodiments, the external storage device 130 may support a single root input/output virtualization (SR-IOV) function of a peripheral component interconnect express (PCIe) interface or the like. The SR-IOV function may be a function of additionally generating virtual I/O ports in the PCIe device having a single root (or port). The external storage device 130 with the SR-IOV function may additionally generate virtual I/O ports in addition to an actual I/O port and may provide the virtual I/O ports to the user device 120. Accordingly, the user device 120 may be provided with a virtual environment similar to an environment in which individual connection with a plurality of storage devices is possible.

The SR-IOV function which is supported by the external storage device 130 may include the device function 131. The device function 131 may include the PF and the VF. The PF may be activated by the integrated controller 110. The activated PF may search devices (e.g., the integrated controller 110 or the user device 120) connected through the PCIe interface, may manage the found devices, and may generate the VF for communication with the user device 120 among the found devices.

The PF may generate or delete the VF corresponding to the user device 120 depending on a request of the integrated controller 110. For example, that the PF generates the VF may mean that an I/O function of data for the user device 120 is activated by activating a physical integrated circuit through the PF. The generated VF may manage the I/O associated with the user device 120 (e.g., may perform a function for the I/O). Each of the PF and the VF may be referred to as the device function 131. The device function 131 may exclusively manage the I/O of the data DT for the corresponding user device 120.

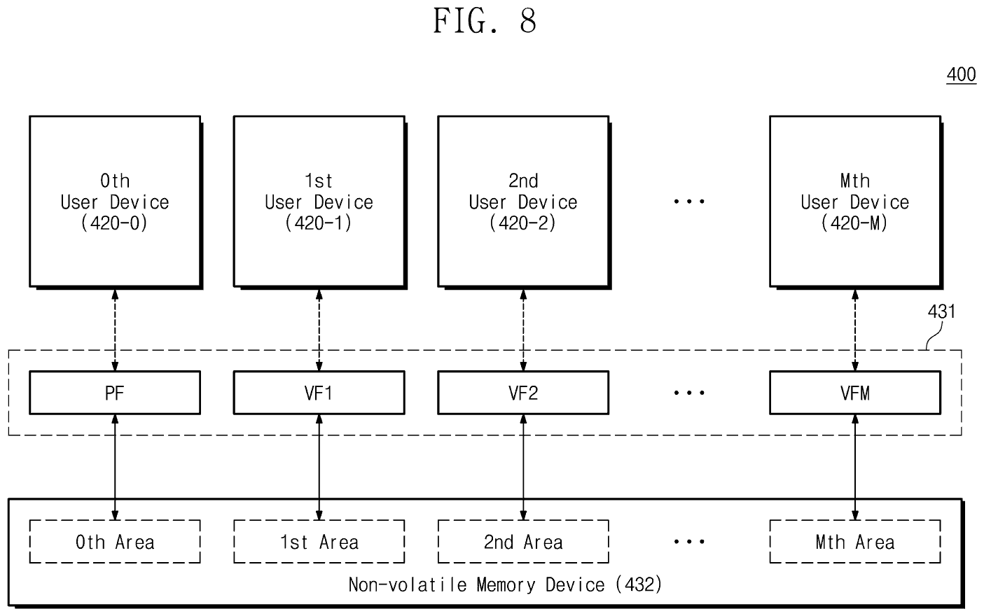

In some embodiments, when the device function 131 is allocated to a plurality of user devices 120, the device functions 131 (or PFs or VFs) respectively corresponding to the plurality of user devices 120 may exclusively use memory areas of the non-volatile memory device 132. For example, the PF may exclusively use a first memory area of the non-volatile memory device 132. Also, the VF may exclusively use a second memory area of the non-volatile memory device 132. The first memory area and the second memory area may be some of areas of the non-volatile memory device 132 and may not overlap each other. The case where the plurality of user devices 120 are connected to the integrated controller 110 will be described in detail with reference to FIG. 8.

The non-volatile memory device 132 may include a plurality of memory chips. Under control of the user device 120, the plurality of memory chips may store the data DT or may provide the stored data DT to the user device 120. The memory chips of the non-volatile memory device 132 may retain the data DT stored therein even though a power supply is interrupted. For example, the memory chips of the non-volatile memory device 132 may be implemented with a NAND flash memory device, a NOR flash memory device, a PRAM, an MRAM, an RRAM, etc.

In some embodiments, the plurality of memory chips of the non-volatile memory device 132 may provide memory areas dedicated for the device function 131. For example, at least some of the plurality of memory chips may provide a memory area dedicated for the PF of the device function 131. At least some of the plurality of memory chips may provide a plurality of memory areas dedicated for the VF of the device function 131.

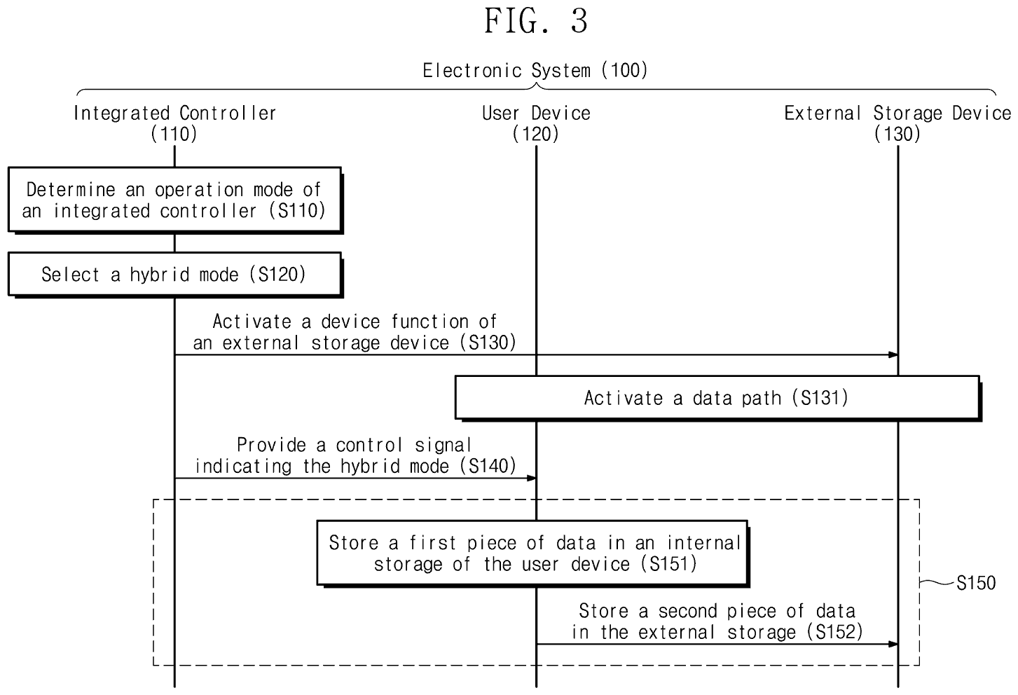

FIG. 3 is a flowchart describing an operating method of an electronic system of FIG. 1, according to some embodiments of the present disclosure. Referring to FIG. 3. The electronic system 100 may include the integrated controller 110, the user device 120, and the external storage device 130.

In operation S110, the integrated controller 110 may determine the operation mode of the integrated controller 110. For example, the integrated controller 110 may select one from among an auto-mode and a manual mode as the operation mode.

In operation S120, the integrated controller 110 may select the hybrid mode as the storage mode of the user device 120. For example, the integrated controller 110 may select the hybrid mode among the internal mode, the external mode, and the hybrid mode as the storage mode of the user device 120. The hybrid mode may refer to a mode in which the user device 120 stores a first piece and a second piece of data in the user device 120 and the external storage device 130, respectively. However, the case where the integrated controller 110 selects the hybrid mode as the storage mode is provided as an example and is not intended to limit the scope and spirit of the present disclosure.

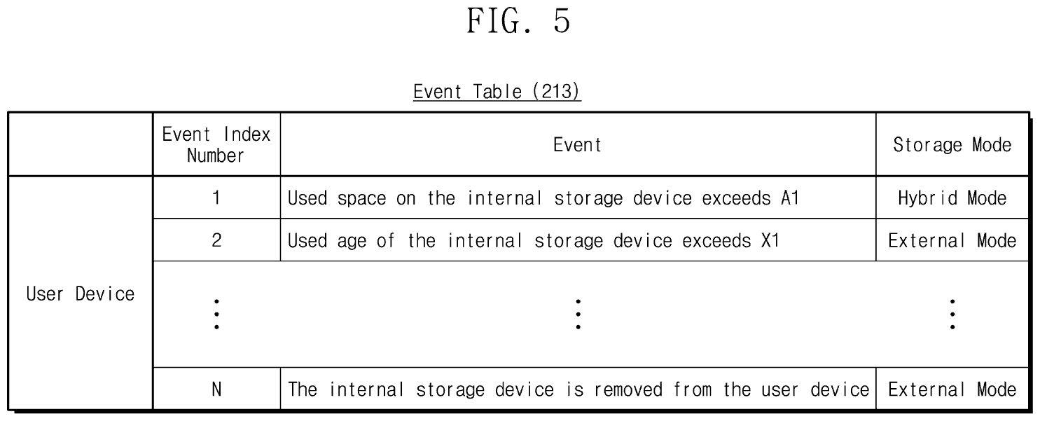

In some embodiments, the integrated controller 110 may operate in the auto-mode and may select the hybrid mode as the storage mode. For example, the integrated controller 110 may select the hybrid mode as the storage mode, based on a signal received from the user device 120. The auto-mode will be described in detail with reference to FIGS. 4 and 5 together.

In some embodiments, the integrated controller 110 may operate in the manual mode and may select the hybrid mode as the storage mode. For example, the integrated controller 110 may select the hybrid mode as the storage mode, based on a signal received from an external device. The manual mode will be described in detail with reference to FIG. 6.

In some embodiments, the integrated controller 110 may update mode information corresponding to the user device 120 in a mode table. For example, the integrated controller 110 may select the hybrid mode as the storage mode and may update the mode information (indicating the hybrid mode) in the mode table included in the integrated controller 110 in response to determining (or changing) the storage mode.

In operation S130, the integrated controller 110 may activate a device function of the external storage device 130. For example, the integrated controller 110 may activate the device function of the external storage device 130 in response to selecting the hybrid mode as the storage mode.

In some embodiments, the external storage device 130 may support the SR-IOV function. The integrated controller 110 may additionally generate a virtual I/O port in addition to an actual I/O port by activating the device function including the SR-IOV function and may provide the generated virtual I/O port to the user device 120.

In some embodiments, the activated device function may be exclusively allocated to the user device 120 (e.g., an ECU of the user device 120). As the integrated controller 110 activates the device function of the external storage device 130, the external storage device 130 may provide a memory area capable of exclusively storing data to the user device 120.

In some embodiments, when the storage mode changes from the hybrid mode to the internal mode, the integrated controller 110 may deactivate the activated device function of the external storage device 130. The integrated controller 110 may remove the additionally generated virtual I/O port by deactivating the device function.

In operation S131, the external storage device 130 may activate a data path between the user device 120 (e.g., the ECU of the user device 120) and the external storage device 130 (e.g., a non-volatile memory device of the external storage device 130). The external storage device 130 may communicate with the user device 120 through the activated data path.

In some embodiments, the external storage device 130 may activate the data path connected to the user device 120 through the actual I/O port or through the virtual I/O port generated by the device function activated in operation S130. The external storage device 130 may communicate with the user device 120 through the actual I/O port or through the data path connected through the virtual I/O port.

In operation S140, the integrated controller 110 may provide the control signal indicating the hybrid mode to the user device 120 (e.g., the ECU of the user device 120), in response to selecting the hybrid mode as the operation mode. In some embodiments, the control signal may include a data frame complying with the communication standard such as a CAN, an LIN, or a FlexRay.

In operation S150, the user device 120 may provide the data generated by the user device 120 (e.g., the ECU of the user device 120) to an internal storage device of the user device 120 or the external storage device 130. Operation S150 may include operation S151 and operation S152. However, operation S151 and operation S152 may not be necessarily performed sequentially. For example, operation S151 and operation S152 may be performed in parallel or may be performed in any other order.

In operation S151, the user device 120 (e.g., the ECU of the user device 120) may receive the control signal indicating the hybrid mode and may then store a first piece of data in the internal storage device of the user device 120. For example, the user device 120 may generate data and may store a first piece among the first piece and a second piece of the generated data in the internal storage device.

In operation S152, the user device 120 (e.g., the ECU) may receive the control signal indicating the hybrid mode and may then store a second piece of data in an external storage device. For example, the user device 120 may generate data and may store a first piece among the first piece and a second piece of the generated data in the internal storage device. The user device 120 may provide a portion of data (e.g., the second piece of the data) to the external storage device 130 and thus may generate and store data whose capacity is larger than a storage space of the internal storage device.

The user device 120 may provide the second piece of the data to the external storage device 130 through the data path. For example, the user device 120 may provide the second piece of the data to the external storage device 130 through the actual I/O port or through the data path connected through the virtual I/O port generated by the device function.

In some embodiments, the user device 120 may store the second piece of the data in a memory area of the external storage device 130, which is exclusively allocated to the user device 120 by the device function. The memory area exclusively allocated to the user device 120 may not overlap any other memory area in the external storage device 130.

The electronic system 100 may repeat operation S150. For example, the user device 120 may receive the control signal indicating the hybrid mode from the integrated controller 110 and may then store data, which the user device 120 (e.g., the ECU of the user device 120) sequentially or repeatedly generates, in the internal storage device and the external storage device 130. The user device 120 may repeat operation S150 until a control signal indicating any other storage mode is received from the integrated controller 110.

In some embodiments, the electronic system 100 may repeat operation S110 to operation S150. For example, the electronic system 100 may repeat operation S110 to operation S150 depending on the select circuit 112 of FIG. 2 selecting one from among the auto-mode and the manual mode as the operation mode.

FIG. 4 is a flowchart describing an operating method of an electronic system according to some embodiments of the present disclosure. Referring to FIG. 4, when the operation mode of an integrated controller 210 is the auto-mode AUTO, an electronic system 200 may determine the storage mode based on a result of monitoring an internal storage device 222.

The integrated controller 210 may include a mode table 211, a select circuit 212, and an event table 213. The integrated controller 210 may operate in the auto-mode AUTO based on the select circuit 212 selecting the auto-mode AUTO.

The event table 213 may include information about a plurality of events and storage modes (e.g., an internal mode, an external mode, and a hybrid mode) respectively corresponding to the plurality of events. The plurality of events may be events capable of occurring in the internal storage device 222. For example, the plurality of events may include an event that the used space of the internal storage device 222 exceeds A % of the total space, an event that the used age of the internal storage device 222 exceeds a time of “X,” or an event that the internal storage device 222 is removed from a user device 220. “A” and “X” are each a real number.

That the used space exceeds A % of the total space may mean that a residual space of the internal storage device 222 is insufficient, that is, may mean that an additional storage space is required. Also, that the used age exceeds the time of “X” may cause a decrease in the performance of the internal storage device 222.

The event table 213 may include information about storage modes of an ECU 221, which respectively correspond to the plurality of events. For example, the event table 213 may include information about the hybrid mode as the storage mode corresponds to the event that the used space of the internal storage device 222 exceeds A %. An event table will be described in detail with reference to FIG. 5.

The integrated controller 210 may provide the information about the plurality of events to the user device 220. For example, the integrated controller 210 may provide the information about the plurality of events included in the event table 213 to the user device 220.

The integrated controller 210 may receive an event detection signal EDS indicating that at least one from among the plurality of events occurs, from the user device 220. For example, the integrated controller 210 may receive the event detection signal EDS indicating that a first event among the plurality of events occurs in the internal storage device 222, from the user device 220.

The integrated controller 110 may select one from among the internal mode, the external mode, and the hybrid mode as the storage mode of the ECU 221 based on the event detection signal EDS. For example, the integrated controller 210 may select the hybrid mode based on the event detection signal EDS indicating the first event and the event table 213 in which the first event and the hybrid mode are matched in a one-to-one correspondence. The integrated controller 210 may update mode information corresponding to the user device 220 in the mode table 211 in response to selecting the hybrid mode.

The integrated controller 210 may activate a device function (DF) 231 included in the external storage device 230. For example, the integrated controller 210 may activate the device function (DF) 231 in response to selecting the external mode or the hybrid mode as the storage mode of the ECU 221. In some embodiments, the integrated controller 210 may activate the device function (DF) 231 such that the ECU 221 stores data in a non-volatile memory device 232.

In some embodiments, the integrated controller 210 may deactivate the device function (DF) 231 of the external storage device 230. For example, the integrated controller 210 may deactivate the device function (DF) 231 in response to selecting the internal mode as the storage mode of the ECU 221. In some embodiments, the integrated controller 210 may deactivate the device function (DF) 231 such that the external storage device 230 deactivates the data path between the user device 220 and the external storage device 230.

The user device 220 may include the ECU 221 and the internal storage device 222. The ECU 221 may receive the information about the plurality of events from the integrated controller 210 and may monitor the internal storage device 222 based on the information about the plurality of events. For example, the ECU 221 may monitor the used space or the used age of the internal storage device 222 or whether the internal storage device 222 is removed from the user device 220.

The ECU 221 may determine that at least one from among the plurality of events occurs. For example, while the ECU 221 monitors the internal storage device 222, the ECU 221 may determine that the used space of the internal storage device 222 exceeds A % of the total space of the internal storage device 222 (may be referred to as a “first event”).

The ECU 221 may generate the event detection signal EDS in response to determining that at least one from among the plurality of events occurs. For example, the ECU 221 may generate the event detection signal EDS corresponding to the first event in response to determining that the first event among the plurality of events occurs. The ECU 221 may generate the event detection signal EDS corresponding to the first event and may then provide the event detection signal EDS to the integrated controller 210.

FIG. 5 is a diagram describing an event table according to some embodiments of the present disclosure. Referring to FIG. 5, the event table 213 may include information about a plurality of events, event index numbers of the plurality of events, and storage modes respectively corresponding to the plurality of events. An example in which the event table 213 includes information about a plurality of events and storage modes associated with one user device is illustrated in FIG. 5 for better understanding of embodiments of the present disclosure, but it should be understood that the scope and spirit of the present disclosure is not limited thereto. The event table 213 may include information about a plurality of events and storage modes for each of two or more user devices.

The plurality of events may be events capable of occurring in the user device 220 of FIG. 4. For example, the plurality of events may include an event that the used space of the internal storage device 222 of FIG. 4 exceeds A1% of the total space, an event that the used age of the internal storage device 222 exceeds a time of “X1,” and/or an event that the internal storage device 222 is removed from the user device 220. “A1” and “X1” are each a real number.

In some embodiments, the plurality of events included in the event table 213 may be updated by the integrated controller 210 of FIG. 4. For example, a first event among the plurality of events included in the event table 213 may be changed, a new event may be added to the event table 213, or an N-th event among the plurality of events may be deleted. Herein, “N” is an arbitrary natural number.

The event index numbers may respectively indicate the plurality of events. For example, Number 1 among the event index numbers may indicate the event that the used space of the internal storage device 222 of FIG. 4 exceeds A1% of the total space, and Number 2 thereof may indicate that the used age of the internal storage device 222 exceeds a time of “X1.” When the number of events is “N,” an event index number range may be from “1” to “N.”

The storage modes may respectively correspond to the plurality of events. For example, the hybrid mode may correspond to the first event. When the ECU 221 of FIG. 4 provides the event detection signal EDS indicating the first event to the integrated controller 210 of FIG. 4 in response to determining that the first event occurs, the integrated controller 210 may select the hybrid mode as the storage mode of the ECU 221 based on the event table 213.

FIG. 6 is a flowchart describing an operating method of an electronic system according to some embodiments of the present disclosure. Referring to FIG. 6, when the operation mode of an integrated controller 310 is the manual mode MANU, an electronic system 300 may select the storage mode of an ECU 321 based on a selection signal SEL received from an external device.

The integrated controller 310 may include a mode table 311, a select circuit 312, and an interface circuit. The integrated controller 310 may receive the selection signal SEL for determining the storage mode from the external device through the interface circuit. The selection signal SEL may indicate one from among the internal mode, the external mode, and the hybrid mode as of the storage mode of the ECU 321.

The integrated controller 310 may select the storage mode of the ECU 321 based on the selection signal SEL. For example, the integrated controller 310 may select the hybrid mode as the storage mode of the ECU 321 based on the selection signal SEL indicating the hybrid mode.

The integrated controller 310 may update the mode table 311 in response to selecting the storage mode. The mode table 311 is similar to the mode table 211 of FIG. 4, and thus, repeated description thereof may be omitted to avoid redundancy.

The integrated controller 310 may provide a control signal indicating the storage mode to a user device 320. The control signal and the user device 320 are similar to the control signal and the user device 220 of FIG. 4, and thus, repeated description thereof may be omitted to avoid redundancy.

The integrated controller 310 may activate a device function (DF) 331 of an external storage device 330 in response to selecting the external mode or the hybrid mode as the storage mode. The external storage device 330 is similar to the external storage device 230 of FIG. 4, and the thus, repeated description thereof may be omitted to avoid redundancy.

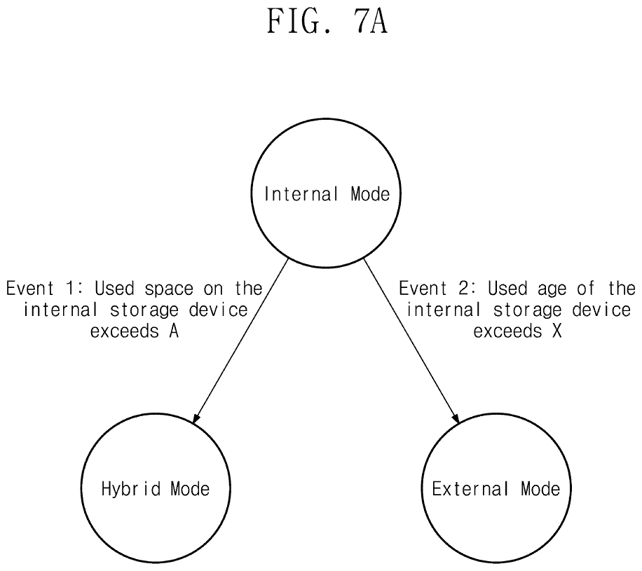

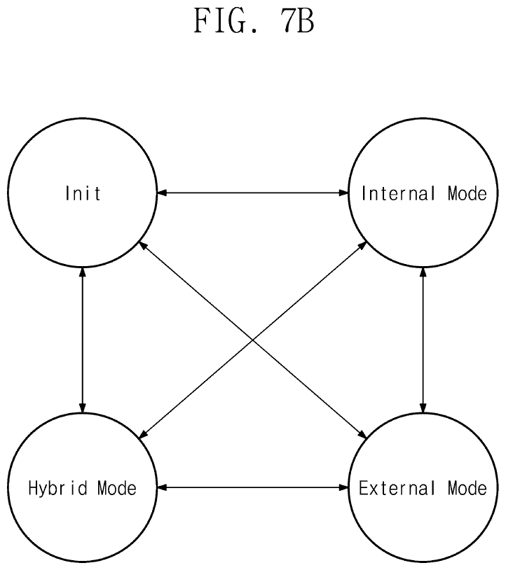

FIG. 7A is a diagram describing a change of a storage device according to some embodiments of the present disclosure. Referring to FIG. 7A, the storage mode may be changed depending on at least one from among a plurality of events occurring. The storage mode may include the internal mode, the external mode, and the hybrid mode.

In some embodiments, the integrated controller 210 of FIG. 4 may select one from among the internal mode, the external mode, and the hybrid mode as the storage mode of the ECU 221 of FIG. 4 in response to at least one from among a plurality of events occurring. For example, when a first event (e.g., an event that the used space of an internal storage device exceeds A % of the total space) occurs in a state where the storage mode of the ECU 221 is the internal mode, the storage mode may be changed from the internal mode to the hybrid mode. Also, when a second event (e.g., an event that the used age of the internal storage device exceeds a time of “X”) occurs, the storage mode may be changed from the internal storage device to the external mode.

FIG. 7B is a diagram describing a change of a storage device according to some embodiments of the present disclosure. Referring to FIG. 7B, the storage mode may include the internal mode, the external mode, the hybrid mode, and an initial mode (Init). The initial mode may refer to a mode which the ECU 321 is capable of having as the storage mode before the integrated controller 310 of FIG. 6 selects one from among the internal mode, the external mode, and the hybrid mode as the storage mode of the ECU 321.

The storage mode may be changed from one from among the initial mode, the internal mode, the external mode, and the hybrid mode to another thereof. For example, the storage mode may be changed from the initial mode to the external mode, and the storage mode may be again changed from the external mode to the initial mode.

As the storage mode is changed, the integrated controller 310 of FIG. 6 may update the mode table 311 and may provide the ECU 321 of FIG. 6 with a control signal indicating the changed (i.e., selected) storage mode.

FIG. 8 is a diagram describing how data are transmitted between a plurality of user devices and an external storage device, according to some embodiments of the present disclosure. Referring to FIG. 8, an electronic system 400 may include (M+1) user devices 420-0 to 420-M, device functions 431, and a non-volatile memory device 432 including (M+1) areas. Herein, “M” is an arbitrary natural number.

The electronic system 400 may support an SR-IOV of an interface or the like. The SR-IOV function may be a function of additionally generating virtual I/O ports in the PCIe device having a single route (or port). The electronic system 400 with the SR-IOV function may additionally generate virtual I/O ports in addition to an actual I/O port and may provide the virtual I/O ports to the first to M-th user device 420-1 to 420-M. Accordingly, the first to M-th user device 420-1 to 420-M may be provided with a virtual environment similar to an environment in which the individual connection with a plurality of storage devices is possible.

The 0-th to M-th user devices 420-0 to 420-M may be different devices. For example, the 0-th to M-th user devices 420-0 to 420-M may be various devices mounted for management and/or operations of a vehicle or other various means of transportation (e.g., a train, an airplane, and a robot). In some embodiments, the 0-th to M-th user devices 420-0 to 420-M may be independent of each other, and each of the 0-th to M-th user devices 420-0 to 420-M may process various information and may generate data.

The 0-th to M-th user devices 420-0 to 420-M may operate in different storage modes. For example, the 0-th user device 420-0 may operate in the internal mode as the storage mode, the user storage device 420-1 may operate in the external mode as the storage mode, and the M-th user device 420-M may operate in the hybrid mode as the storage mode.

The device functions 431 may include the PF and first to M-th VFs VF1 to VFM. The PF may correspond to the 0-th user device 420-0, and the first to M-th VFs VF1 to VFM may respectively correspond to the first to M-th user device 420-1 to 420-M.

In some embodiments, the PF may search for a device (e.g., the 0-th to M-th user devices 420-0 to 420-M) connected through the PCIe interface, may manage the found devices, and may generate the first to M-th VFs VF1 to VFM for communication with virtual devices among the found devices.

The PF may generate or delete the first to M-th VFs VF1 to VFM corresponding to the first to M-th user device 420-1 to 420-M. For example, that the PF generates the first to M-th VFs VF1 to VFM may mean that a physical integrated circuit is activated by the PF such that an I/O function of data for the first to M-th user device 420-1 to 420-M is activated. The first to M-th VFs VF1 to VFM thus generated may manage the I/Os for the first to M-th user device 420-1 to 420-M (e.g., may perform functions for the I/Os). Each of the PF and the first to M-th VFs VF1 to VFM may be also referred to as the device functions 431. The device functions 431 may exclusively manage I/Os of data for the 0-th to M-th user devices 420-0 to 420-M, respectively. According to embodiments, device functions (e.g., a first device function and a second device function) among the device functions 431 may be separately provided.

In some embodiments, when the device function 431 is allocated to the 0-th to M-th user devices 420-0 to 420-M, the PF and the first to M-th VFs VF1 to VFM which respectively correspond to the 0-th to M-th user devices 420-0 to 420-M may exclusively and respectively use the 0-th to M-th memory areas of the non-volatile memory device 432. For example, the PF may exclusively use the 0-th memory area of the non-volatile memory device 432. Also, the first VF may exclusively use the first memory area of the non-volatile memory device 432. The 0-th memory area and the 1-st memory area may be some of the areas of the non-volatile memory device 432 and may not overlap each other.

The PF and the first to M-th VFs VF1 to VFM may respectively activate data paths between the non-volatile memory device 432 and the 0-th to M-th user devices 420-0 to 420-M respectively corresponding thereto. Each of the 0-th to M-th user devices 420-0 to 420-M may communicate with the non-volatile memory device 432 through the corresponding data path.

In some embodiments, the PF and the first to M-th VFs VF1 to VFM may be activated or deactivated depending on the storage modes of the 0-th to M-th user devices 420-0 to 420-M respectively corresponding thereto. For example, when the storage mode of the first user device 420-1 is the internal mode, the first VF VF1 may be deactivated; when the storage mode of the M-th user device 420-M is the hybrid mode, the M-th VF VFM may be activated.

In some embodiments, the 0-th to M-th user devices 420-0 to 420-M may respectively store data in the 0-th to M-th areas of the non-volatile memory device 432, which the PF and the first to M-th VFs VF1 to VFM are capable of using exclusively and respectively. For example, the 0-th user device 420-0 may store data in the 0-th area of the non-volatile memory device 432, and the M-th user device 420-M may store data in the M-th area of the non-volatile memory device 432.

In some embodiments, the non-volatile memory device 432 may support the crypto erase function. For example, the data of the 0-th to M-th user devices 420-0 to 420-M may be encrypted and may be stored in the non-volatile memory device 432. Afterwards, an encryption key capable of decoding or decrypting the encrypted data of the 0-th to M-th user devices 420-0 to 420-M stored in the non-volatile memory device 432 may be deleted. That is, as the crypto erase function on the non-volatile memory device 432 is performed, the data of the 0-th to M-th user devices 420-0 to 420-M stored in the non-volatile memory device 432 may be deleted all at once (and safely in compliance with the security rule capable of being required).

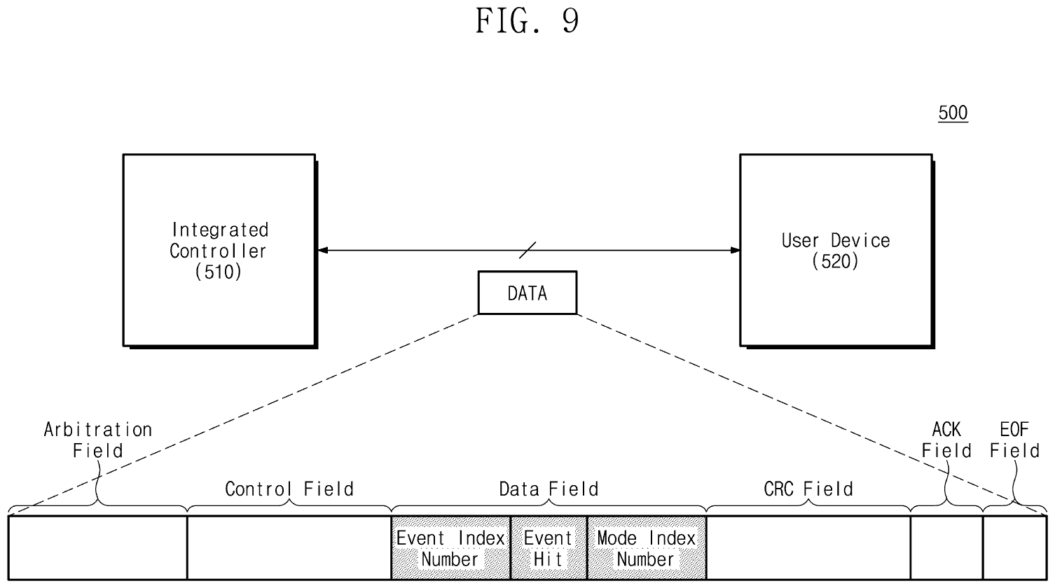

FIG. 9 is a diagram describing a controller area network (CAN) frame according to some embodiments of the present disclosure. Referring to FIG. 9, an integrated controller 510 and a user device 520 may communicate by using a CAN frame of the CAN communication standard.

The CAN frame may include an arbitration field, a control field, a data field, a cyclic redundancy check (CRC) field, an acknowledge (ACK) field, and an end of framefiled (EOF) field.

The data field may include an event index number area, an event hit notification area, and a mode index number area. The event index number area may include event index numbers indicating a plurality of events, respectively. The event hit notification area may indicate whether an event indicated by an event index number occurs. Also, the mode index number area may include mode index numbers respectively indicating the internal mode, the external mode, and the hybrid mode among storage modes.

For better understanding of embodiments of the present disclosure, although an example of the CAN frame of the CAN communication standards which the integrated controller 510 and the user device 520 are capable of using is described, for the integrated controller 510 and the user device 520 to communicate with each other, the LIN, the FlexRay, etc., may be used instead of the CAN frame, depending on the implementation method of the electronic system 500.

According to an embodiment of the present disclosure, an electronic system mounted on a vehicle including an external storage device and an operating method thereof are provided.

Also, the electronic system mounted on the vehicle may provide a storage resource of external storage to an ECU. Accordingly, a storage space to be provided to the ECU may increase, a maximum data bandwidth of the ECU may be extended, and the burden of internal storage may be distributed into the external storage.

While non-limiting example embodiments of the present disclosure have been described with reference to the drawings, it will be apparent to those of ordinary skill in the art that various changes and modifications may be made thereto without departing from the spirit and scope of the present disclosure.

1. An electronic system mounted on a vehicle, comprising:
a first user device comprising a first electronic control unit (ECU) and a first internal storage device;
an external storage device comprising a first device function, exclusively allocated to the first ECU, and a non-volatile memory device; and
an integrated controller configured to:
select a hybrid mode among an internal mode and the hybrid mode as a storage mode of the first ECU;
activate the first device function based on selecting the hybrid mode; and
provide a first control signal indicating the hybrid mode to the first ECU,
wherein the first ECU is configured to, based on the first ECU receiving the first control signal, store a first piece of first data in the first internal storage device and store, through the first device function, a second piece of the first data in the non-volatile memory device.

2. The electronic system of claim 1, wherein the first ECU is configured to:
receive information about a plurality of events from the integrated controller; and
provide an event detection signal to the integrated controller based on monitoring the first internal storage device,
wherein the integrated controller further comprises an event table,
wherein the integrated controller is further configured to select the hybrid mode based on the event detection signal received from the first user device, and
wherein the event table comprises information about the plurality of events and storage modes respectively corresponding the plurality of events.

3. The electronic system of claim 2, wherein the plurality of events comprise:
a first event indicating that a used space of the first internal storage device exceeds a first threshold value;
a second event indicating that a used age of the first internal storage device exceeds a second threshold value; and
a third event indicating that the first internal storage device is physically damaged.

4. The electronic system of claim 1, wherein the integrated controller further comprises:
a select circuit configured to select one from among an auto-mode and a manual mode as an operation mode of the integrated controller; and
an interface circuit configured to:
be activated based on the manual mode being selected; and
receive a selection signal for determining the storage mode of the integrated controller from an external device, and
wherein the integrated controller is further configured to select the hybrid mode based on the selection signal.

5. The electronic system of claim 1, wherein the integrated controller comprises a mode table comprising information about the storage mode of the first user device, and
wherein the integrated controller is further configured to update mode information corresponding to the first user device in the mode table based on the hybrid mode being selected.

6. The electronic system of claim 1, wherein the integrated controller is further configured to:
select an external mode as the storage mode of the first ECU;
activate the first device function based on selecting the external mode; and
provide a second control signal indicating the external mode to the first ECU, and
wherein the first ECU is configured to, based on the first ECU receiving the second control signal, release a connection for the first internal storage device, and store the first data in the non-volatile memory device through the first device function.

7. The electronic system of claim 1, wherein the integrated controller is further configured to, based on the integrated controller selecting the hybrid mode:
select the internal mode as the storage mode;
deactivate the first device function based on selecting the internal mode; and
provide a second control signal indicating the internal mode to the first ECU.

8. The electronic system of claim 1, further comprising:
a second user device comprising a second ECU and a second internal storage device,
wherein the external storage device further comprises a second device function exclusively allocated to the second ECU,
wherein the integrated controller is further configured to:
activate the second device function based on selecting the hybrid mode as a storage mode of the second ECU; and
provide a second control signal indicating the hybrid mode to the second ECU, and
wherein the second ECU is configured to, based on the second ECU receiving the second control signal, store a first piece of second data in the second internal storage device and store, through the second device function, a second piece of the second data in the non-volatile memory device.

9. The electronic system of claim 8, wherein the first device function and the second device function allocate a first memory area and a second memory area of the non-volatile memory device to the first ECU and the second ECU, respectively.

10. The electronic system of claim 2, wherein the integrated controller and the first user device are configured to communicate by using a controller area network (CAN) frame of a CAN communication standard,
wherein the CAN frame constitutes the event detection signal and comprises a data field comprising an event index number, an event hit notification, and a storage mode index number, and
wherein the event index number distinguishes the plurality of events, the event hit notification indicates that at least one from among the plurality of events occurs, and the storage mode index number distinguishes the storage modes.

11. The electronic system of claim 1, wherein the external storage device supports a single root input/output virtualization (SR-IOV) function.

12. The electronic system of claim 1, further comprising:
an interface circuit electrically connected to the integrated controller and detachably connected to the external storage device.

13. The electronic system of claim 1, wherein the external storage device is embedded in the vehicle and is fixedly connected to the integrated controller.

14. The electronic system of claim 1, wherein the external storage device is configured to:
receive the second piece of the first data from the first ECU;
generate a third piece by encrypting the second piece by using an encryption key; and
store the third piece, and
wherein the external storage device supports a crypto erase function of erasing the encryption key.

15. A method of operating an electronic system that is mounted on a vehicle and includes an integrated controller, a first user device, and an external storage device, the method comprising:
selecting, by the integrated controller, a hybrid mode among an internal mode and the hybrid mode as a storage mode of a first electronic control unit (ECU) of the first user device;
activating, by the integrated controller, a first device function of the external storage device based on the integrated controller selecting the hybrid mode;
activating, by the first device function that is activated, a data path between the first ECU and a non-volatile memory device of the external storage device;
providing a first control signal indicating the hybrid mode to the first ECU based on the integrated controller selecting the hybrid mode;
storing, by the first ECU and based on the first ECU receiving the first control signal, a first piece of first data in a first internal storage device of the first user device; and
storing, by the first ECU and based on the first ECU receiving the first control signal, a second piece of the first data in the non-volatile memory device through the first device function.

16. The method of claim 15, wherein the selecting the hybrid mode comprises:
providing, by the integrated controller, information about a plurality of events to the first ECU;
determining, by the first ECU, that at least one from among the plurality of events occurs, based on monitoring of the first internal storage device;
generating, by the first ECU, an event detection signal, based on determining that the at least one from among the plurality of events occurs,
providing, by the first ECU, the event detection signal to the integrated controller; and
selecting, by the integrated controller, the hybrid mode based on the event detection signal and an event table, and
wherein the event table includes information about the plurality of events and storage modes respectively corresponding the plurality of events.

17. The method of claim 15, wherein the selecting the hybrid mode comprises:
selecting, by the integrated controller, a manual mode among an auto-mode and the manual mode as an operation mode of the integrated controller;
receiving, by the integrated controller and after selecting the manual mode, a selection signal indicating the hybrid mode from an external device; and
selecting, by the integrated controller, the hybrid mode based on the selection signal.

18. The method of claim 15, wherein the selecting the hybrid mode comprises:
updating mode information corresponding to the first user device in a mode table based on the hybrid mode being selected by the integrated controller, and
wherein the mode table includes information about the storage mode of the first user device.

19. The method of claim 15, further comprising:
selecting, by the integrated controller, an external mode as the storage mode;
activating, by the integrated controller, the first device function of the external storage device based on the integrated controller selecting the external mode;
activating, by the first device function that is activated and after the external mode is selected, the data path between the first ECU and the non-volatile memory device;
providing a second control signal indicating the external mode to the first ECU based on the integrated controller selecting the external mode; and
releasing, by the first ECU, a connection for the first internal storage device based on the first ECU receiving the second control signal.

20. (canceled)

21. An electronic system comprising:
a first user device;
an external storage device comprising a first device function configured to be exclusively allocated to the first user device; and
a controller configured to:
select a hybrid mode among an internal mode and the hybrid mode as a storage mode of the first user device;
activate the first device function based on selecting the hybrid mode; and
provide a first control signal indicating the hybrid mode to the first user device,
wherein the first user device is configured to, based on the first user device receiving the first control signal, store a first piece of first data in the first user device and store, through the first device function, a second piece of the first data in the external storage device.
